(19) United States
(12) Patent Application Publication
(10) Pub. No.: US 2016/0351314 A1
(43) Pub. Date: Dec. 1, 2016

(54) ELECTRONIC COMPONENT

(71) Applicant: SAMSUNG ELECTRO-MECHANICS CO., LTD., Suwon-si (KR)

(72) Inventors: Dong Jin JEONG, Suwon-si (KR); Kyung Seop LEE, Suwon-si (KR)

(21) Appl. No.: 15/091,466

(22) Filed: Apr. 5, 2016

(30) Foreign Application Priority Data
May 26, 2015 (KR) 10-2015-0072710

(51) Int. Cl. H01F 27/24; H01F 27/29

(52) U.S. Cl. CPC H01F 27/24; H01F 27/29

(57) ABSTRACT

An electronic component includes at least one current path blocking part formed in a surface of a magnetic body in a direction crossing a direction in which terminals of a coil part are exposed. The current path of the fine current flowing on the surface of the magnetic body may be blocked by the current path blocking part, when a high voltage is applied. The current path of the current flowing in the magnetic body may be formed as long as possible, whereby the fine current flowing on the surface of the inductor may be removed or decreased.

### CROSS-REFERENCE TO RELATED APPLICATION

This application claims benefit of priority to Korean Patent Application No. 10-2015-0072710 filed on May 26, 2015, with the Korean Intellectual Property Office, the disclosure of which is incorporated herein by reference.

### TECHNICAL FIELD

The present disclosure relates to an electronic component.

### BACKGROUND

An inductor, an electronic component, is a representative passive element configuring an electronic circuit together with a resistor and a capacitor to remove noise, or is used in a component configuring an LC resonance circuit, or the like.

In accordance with the recent trend toward an increase in the complexity and multi-functionalization of electronic products, compact size, a capacity for large current, and high capacity have been gradually required in electronic components used in said electronic products.

In particular, in a case of a power inductor used in a power management integrated circuit (PMIC) or a direct current (dc)-dc converter (DDC), a structure supplying power to an integrated circuit (IC) is changed to a structure in which several power inductors are used around the PMIC.

Further, since the power inductor has a capacity for large current and high frequency in accordance with an increase in the complexity of products, it is important to improve withstand voltage characteristics of the inductor.

### SUMMARY

An aspect of the present disclosure may provide an electronic component capable of removing or decreasing a fine current flowing on a surface of an inductor when a high voltage is applied.

According to an aspect of the present disclosure, an electronic component may include at least one current path blocking part formed in a surface of a magnetic body in a direction crossing a direction in which terminals of a coil part are exposed.

According to another aspect of the present disclosure, an electronic component may include: a magnetic body including a coil part exposed to both end portions thereof in a length direction and upper and lower cover layers disposed on and below the coil part, respectively, and having at least one recessed part formed in one main surface of the upper or lower cover layer in a direction crossing the length direction; and external electrodes formed on both end portions of the magnetic body in the length direction and connected to exposed portions of the coil part, respectively.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a transparent perspective view schematically illustrating an electronic component according to an exemplary embodiment in the present disclosure so that a coil part thereof is visible;

FIG. 2 is a cross-sectional view taken along line I-I′ of FIG. 1;

FIG. 3 is a perspective view of the electronic component illustrated in FIG. 1;

FIG. 4 is a plan view of the electronic component illustrated in FIG. 1;

FIG. 5 is a side view of the electronic component illustrated in FIG. 1;

FIG. 6 is a perspective view schematically illustrating an electronic component according to another exemplary embodiment in the present disclosure; and

FIG. 7 is a perspective view schematically illustrating an electronic component according to another exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Electronic Component

In an electronic component according to an exemplary embodiment, at least one current path blocking part may be formed in a surface of a magnetic body in a direction crossing a direction in which terminals of a coil part are exposed.

In addition, the current path blocking part may be formed of a recessed part formed in at least one main surface of the magnetic body.

Hereinafter, the electronic component according to the exemplary embodiment, particularly, a thin film type inductor, will be described. However, the electronic component is not necessarily limited thereto.

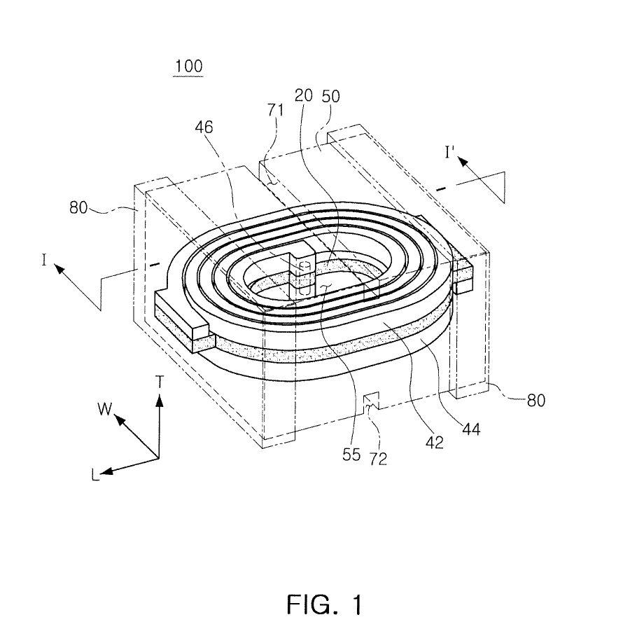

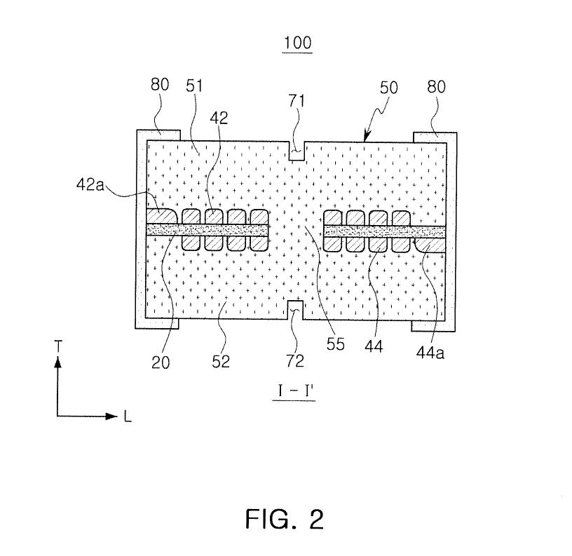

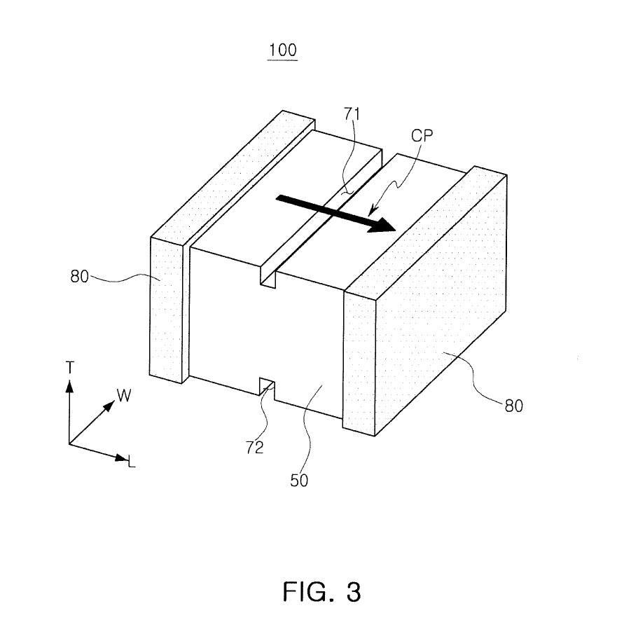

FIG. 1 is a transparent perspective view schematically illustrating an electronic component according to an exemplary embodiment so that an internal coil part thereof is visible, FIG. 2 is a cross-sectional view taken along line I-I′ of FIG. 1, and FIG. 3 is a perspective view of the electronic component illustrated in FIG. 1.

Referring to FIGS. 1 through 3, a thin film type inductor 100 is illustrated as an example of the electronic component.

In the thin film type inductor 100 according to the exemplary embodiment, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

The thin film type inductor 100 according to the exemplary embodiment may include a magnetic body 50, and a pair of external electrodes 80 formed on both end portions of the magnetic body 50 in the length direction.

In addition, the magnetic body 50 may include a coil part disposed therein, and upper and lower cover layers 51 and 52 disposed on and below the coil part, respectively.

The magnetic body 50 may form an exterior of the thin film type inductor 100 and contain, for example, ferrite or metal magnetic particles, but the material of the magnetic body 50 is not necessarily limited thereto. That is, the magnetic body may contain various materials without limitation as long as the material exhibits magnetic properties.

Further, the metal magnetic particles may be formed of an alloy containing any one or more selected from the group consisting of iron (Fe), silicon (Si), chromium (Cr), aluminum (Al), and nickel (Ni). For example, the metal magnetic particles may contain Fe—Si—B—Cr based amorphous metal particles, but are not necessarily limited thereto.

In this case, if necessary, the metal magnetic particles may be contained in a form in which the metal magnetic particles are dispersed in a polymer such as an epoxy resin, polyimide, or the like, and thus, an insulating property of a surface may be secured.

The coil part may include a coil supporting layer 20 disposed between the upper and lower cover layers 51 and 52 and first and second coil layers 42 and 44.

The coil supporting layer 22 may be formed of, for example, an insulating substrate, and more specifically, one of polypropylene glycol (PPG) substrates, ferrite substrates, metal-based soft magnetic substrates, and the like. However, the coil supporting layer 20 is not limited thereto.

A hole penetrating through a central portion of the coil supporting layer 20 may be formed, and the hole may be filled with a magnetic material such as the ferrite, the metal magnetic particles, or the like, thereby forming a central portion 55.

As the central portion 55 filled with the magnetic material is formed, inductance L of the inductor may be improved.

The first and second coil layers 42 and 44 may be disposed on one surface and the other surface of the coil supporting layer 20, respectively.

The first and second coil layers 42 and 44 may be formed of a pattern such as a spiral shape.

The first and second coil layers 42 and 44 disposed on one surface and the other surface of the coil supporting layer 20, respectively, with the coil supporting layer 20 interposed therebetween as described above may be electrically connected to each other through at least one via electrode 46 penetrating through the coil supporting layer 20 perpendicular to the length direction.

In this case, the first and second coil layers 42 and 44 and the via electrode 46 may be formed of a metal having excellent electrical conductivity. For example, the first and second coil layers 42 and 44 and the via electrode 46 may be formed of at least one of silver (Ag), palladium (Pd), aluminum (Al), nickel (Ni), titanium (Ti), gold (Au), copper (Cu), and platinum (Pt), or alloys thereof.

In addition, a terminal 42a of the first coil layer 42 formed on one surface of the coil supporting layer 20 may be exposed to one end surface of the magnetic body 50 in the length direction, and a terminal 44a of the second coil layer 44 formed on the other surface of the coil supporting layer 20 may be exposed to the other end surface of the magnetic body 50 in the length direction.

Further, one or more recessed parts 71 and 72, for example, having a groove shape, may be formed in a direction crossing the length direction in which terminals 42a and 44a of the first and second coil layers 42 and 44 of the coil part are exposed, on one surface of the upper or lower cover layer 51 or 52 of the magnetic body 50 in the thickness direction, respectively.

Although the recessed parts 71 and 72 formed in one surfaces of the upper and lower cover layers 51 and 52 in the thickness direction, respectively, are illustrated and described in the present exemplary embodiment, the recessed parts 71 and 72 are not limited thereto. That is, the recessed parts 71 and 72 may be formed only in the upper cover layer or the lower cover layer.

Further, according the present exemplary embodiment, the recessed parts 71 and 72 may be linear groove parts. For example, the linear recessed parts 71 and 72 having a linear groove shape may extend in the width direction crossing the length direction in which the terminals 42a and 44a of the first and second coil layers 42 and 44 are exposed.

In this case, the recessed parts 71 and 72 may be formed to intersect perpendicularly to the length direction in which the terminals 42a and 44a of the first and second coil layers 42 and 44 are exposed. If necessary, the recessed parts 71 and 72 may be formed in a direction crossing or obliquely crossing the length direction, in which the terminals 42a and 44a of the first and second coil layers 42 and 44 are exposed, at an angle of 90° or so, or 90° or more.

In addition, the recessed parts 71 and 72 may be formed to be elongated in a straight line shape so that the recessed parts 71 and 72 are opened through both side surfaces of the upper or lower cover layer 51 or 52 in the width direction.

In this case, the recessed parts 71 and 72 may be formed so that an edge of the upper or lower cover layer 51 or 52 connecting one surface of the upper or lower cover layer 51 or 52 in the thickness direction and one side surface thereof in the width direction to each other is opened.

However, the recessed parts 71 and 72 are not limited thereto, and if necessary, the recessed parts 71 and 72 may be formed to be curved in an arc shape or bent to be curved at central portions thereof.

Meanwhile, a coating layer (not illustrated) formed of an insulating material such as an epoxy may be formed in the recessed parts 71 and 72. The coating layer as described above may more effectively improve a role of blocking a current path between the external electrodes 80 or increasing a length of the current path therebetween.

The pair of external electrodes 80 may be formed on both end portions of the magnetic body 50 in the length direction.

The pair of external electrodes 80 as described above may be electrically connected to the terminals 42a and 44a of the first and second coil parts 42 and 44 exposed to both end surfaces of the magnetic body 50 in the length direction.

When a withstand voltage is applied to an electronic component, it is important to reinforce an insulating property of a surface of the electronic component of which current conductivity is the highest, and a current path of the surface flows in a length direction in which terminals are formed.

According to the present exemplary embodiment, a current path CP of a fine current flowing on the surface of the magnetic body 50 in the length direction a high voltage is applied may be partially blocked by the recessed parts 71 and 72 formed in the direction crossing the length direction, and the current path may be formed to be elongated, whereby the fine current flowing on the surface of the magnetic body 50 may be removed.

In the case of the above-mentioned structure, when surface resistance is measured after applying a withstand voltage, the surface resistance may be 10⁵Ω or more.

The external electrodes 80 may contain a metal having excellent electric conductivity. For example, the external electrodes 80 may be formed of one of nickel (Ni), copper (Cu), tin (Sn), silver (Ag), and the like, or alloys thereof. However, a material of the external electrodes 80 is not necessarily limited thereto.

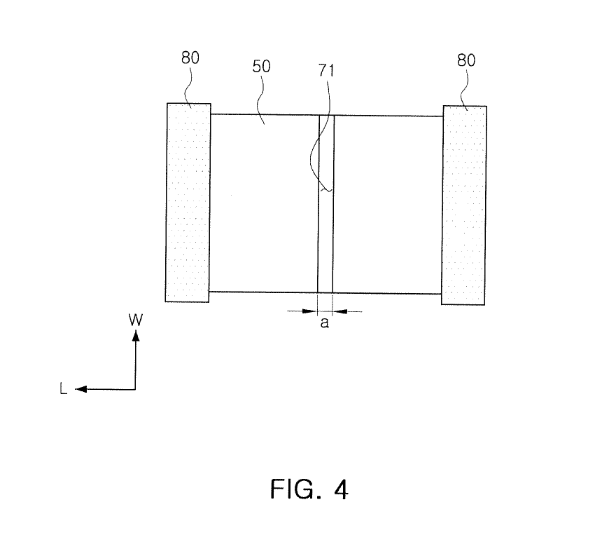

FIG. 4 is a plan view of the electronic component 100 illustrated in FIG. 1.

Referring to FIG. 4, a width a of the recessed parts 71 and 72 may be 3 μm to 100 μm.

When the width a of the recessed parts 71 and 72 is less than 3 μm, an effect of blocking the current path may be insufficient, and when the width a of the recessed parts 71 and 72 is more than 100 μm, inductance may be decreased.

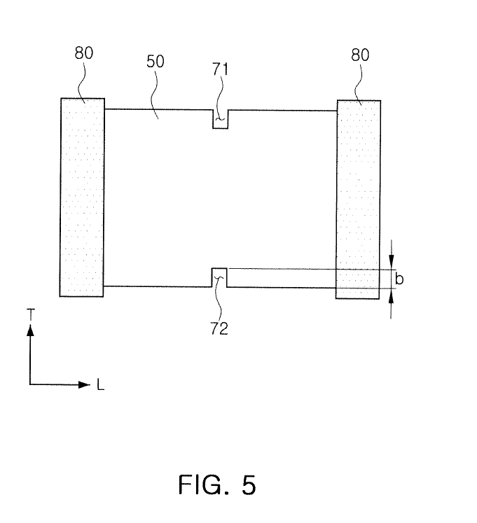

FIG. 5 is a side view of the electronic component 100 illustrated in FIG. 1.

Referring to FIG. 5, a depth b of the recessed parts 71 and 72 may be 3 μm to 100 μm.

When the depth b of the recessed parts 71 and 72 is less than 3 μm, the effect of blocking the current path may be insufficient, and when the depth b of the recessed parts 71 and 72 is more than 100 μm, inductance may be decreased.

### Modified Exemplary Embodiment

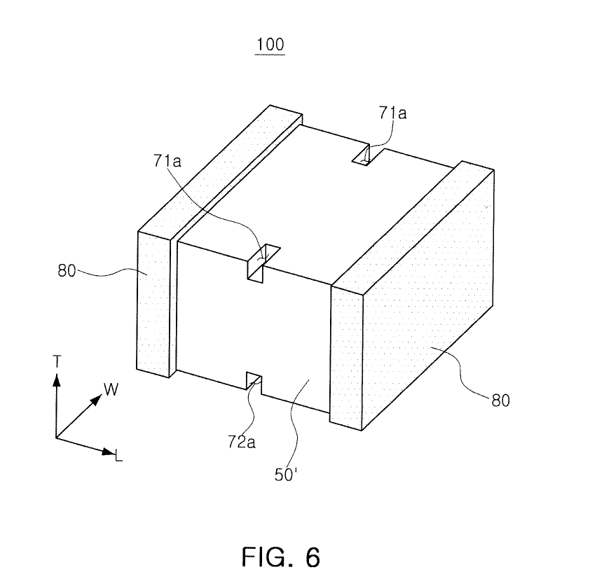

FIG. 6 is a perspective view schematically illustrating an electronic component according to another exemplary embodiment.

Here, since structures of a coil part and external electrodes are similar to those of the coil part and the external electrodes in the exemplary embodiment described above, a detailed description thereof will be omitted in order to avoid an overlapping description.

Referring to FIG. 6, recessed parts according to another exemplary embodiment may include a pair of upper recessed parts 71a formed only in edges of an upper cover layer 51 of a magnetic body 50′ connecting one surface of the upper cover layer 51 in a thickness direction and both side surfaces thereof in a width direction to each other, and a pair of lower recessed parts 72a formed only in edges of a lower cover layer 52 of the magnetic body 50′ connecting one surface of the lower cover layer 52 in the thickness direction and both side surfaces thereof in the width direction to each other.

Here, the pair of upper recessed parts 71a may be disposed at positions opposing each other in the width direction. Alternatively, if necessary, the pair of upper recessed parts 71a may be misaligned with each other in the width direction to thereby be disposed at positions not opposing each other.

Further, the pair of lower recessed parts 72a may be disposed at positions opposing each other in the width direction. Alternatively, if necessary, the pair of lower recessed parts 72a may be misaligned with each other in the width direction to thereby be disposed at positions not opposing each other.

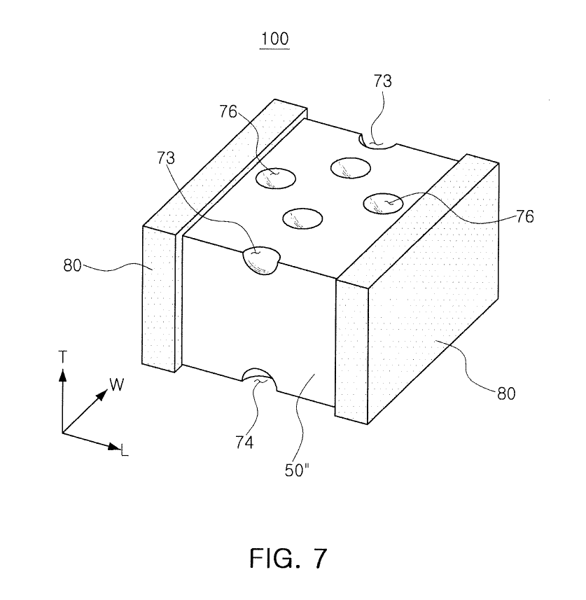

FIG. 7 is a perspective view schematically illustrating an electronic component according to another exemplary embodiment.

Since structures of a coil part and external electrodes are similar to those of the coil part and the external electrodes in the exemplary embodiment described above, a detailed description thereof will be omitted in order to avoid an overlapping description.

Referring to FIG. 7, recessed parts according to another exemplary embodiment may be depressed to be concave inwardly from a surface of an upper or lower cover layer 51 or 52 of a magnetic body 50″ and have a circular cross section.

In this case, recessed parts 73 and 74 may be formed in edges connecting one surface of the upper or lower cover layer 51 or 52 in a thickness direction and both side surfaces thereof to each other. In addition, a plurality of recessed parts 75 and 76 may be discontinuously and randomly disposed in one surface of the upper or lower cover layer 51 or 52 in the thickness direction.

Further, if necessary, shapes of the recessed parts may be variously changed. For example, the recessed parts may be formed to be elongated in the width direction of the magnetic body as in the exemplary embodiment described above, or may be extended to be opened from one surface of the upper or lower cover layer in the thickness direction to both side surfaces thereof in the width direction.

Moreover, if necessary, surfaces in which the recessed parts are formed may be variously changed. For example, the recessed parts may be formed substantially in one or both surfaces in the thickness direction as in the exemplary embodiments described above, or may be formed substantially in one or both surfaces in the width direction instead, or may be formed substantially in one or more surfaces or substantially in all surfaces in the thickness direction and the width direction. According to one embodiment, the recess part may extend continuously in all the surfaces in the thickness and width directions and surround the coil part.

As set forth above, according to exemplary embodiments, the current path of the fine current flowing on the surface of the magnetic body may be blocked by the current path blocking part, when a high voltage is applied. The current path of the current flowing in the magnetic body may be formed as long as possible, whereby the fine current flowing on the surface of the inductor may be removed or decreased.

While exemplary embodiments have been shown and described above, it will be apparent to those skilled in the art that modifications and variations could be made without departing from the scope of the present invention as defined by the appended claims.

What is claimed is:

1. An electronic component, comprising:
a magnetic body;
a coil part disposed in the magnetic body and including terminals exposed to opposite surfaces of the magnetic body in a length direction; and
at least one current path blocking part formed in a surface of the magnetic body in a direction crossing the length direction.

2. The electronic component of claim 1, wherein the current path blocking part is a recessed part formed in the surface of the magnetic body.

3. The electronic component of claim 2, wherein the recessed part has a linear groove shape.

4. The electronic component of claim 3, wherein the recessed part has a depth of 3 μm to 100 μm.

5. The electronic component of claim 2, wherein the recessed part comprises a plurality of recesses discontinuously disposed in the surface of the magnetic body and each recess having a circular cross section.

6. The electronic component of claim 1, wherein the current path blocking part is a recessed part formed in an edge of the magnetic body connecting the surface and another surface adjacent to the surface of the magnetic body.

7. The electronic component of claim 6, wherein the recessed part has a linear groove shape.

8. The electronic component of claim 1, wherein the current path blocking part has a linear groove shape formed in the surface of the magnetic body to be perpendicular to the length direction, and the current path blocking part having the linear groove shape extends continuously between opposite side surfaces of the magnetic body which are connected by the surface of the magnetic body.

9. An electronic component comprising:
a magnetic body including a coil part exposed to both end portions thereof in a length direction and upper and lower cover layers disposed on and below the coil part, respectively, and having at least one recessed part formed in a surface of the upper or lower cover layer in a direction crossing the length direction; and
external electrodes formed on the both end portions of the magnetic body in the length direction and connected to exposed portions of the coil part, respectively.

10. The electronic component of claim 9, wherein the coil part includes a coil supporting layer disposed between the upper and lower cover layers; and first and second coil layers disposed on upper and lower surfaces of the coil supporting layer and connected to each other through a via electrode.

11. The electronic component of claim 9, wherein the recessed part has a linear groove shape.

12. The electronic component of claim 11, wherein the recessed part has a depth of 3 μm to 100 μm.

13. The electronic component of claim 9, wherein the recessed part comprises a plurality of recesses discontinuously disposed in the surface of the upper or lower cover layer and each recess having a circular cross section.

14. The electronic component of claim 9, wherein the recessed part is formed in an edge of the upper or lower cover layer connecting the surface and another surface adjacent to the surface of the upper or lower cover layer.

15. The electronic component of claim 14, wherein the recessed part has a linear groove shape.

16. The electronic component of claim 9, wherein the recessed part having a linear groove shape is formed in a main surface of the upper or lower cover layer to be perpendicular to the length direction, and the recessed part extends continuously between opposite side surfaces of the upper or lower cover layer which are connected by the main surface of the upper or lower cover layer.

17. An electronic component, comprising:
a magnetic body;
a coil part including first and second coil layers stacked in a thickness direction in the magnetic body and having terminals exposed to opposite surfaces of the magnetic body in a length direction; and
a recess part formed in a surface in the thickness direction.

18. The electronic component of claim 17, comprising an insulating material coated on a surface of the recessed part.

19. The electronic component of claim 17, wherein the recess part extends continuously between opposite edges of the surface in the thickness direction.

20. The electronic component of claim 17, wherein the recess part includes a plurality of recesses spaced apart from each other.
